(19) United States
(12) Patent Application Publication
(10) Pub. No.: US 2006/0169149 A1
(43) Pub. Date: Aug. 3, 2006

(54) Basket for holding coffee grounds in coffee brewing machine

(76) Inventors: Margaret E. Voss, Thornton, IL (US); Mary A. Puglise, Thornton, IL (US)

Correspondence Address: Michael J. Femal - Attorney at Law, 812 N. Belmont Ave., Arlington Heights, IL, 60004-5606, US

(21) Appl. No.: 11/345,915

(22) Filed: Feb. 2, 2006

Related U.S. Application Data
(60) Provisional application No. 60/649,488, filed on Feb. 3, 2005.
(60) Provisional application No. 60/649,493, filed on Feb. 3, 2005.

(51) Int. Cl. A47J 31/44

(52) U.S. Cl. 99/279

(57) ABSTRACT

A configurable stationary basket for a single cup coffee maker having interchangeable parts for brewing beverages which permit the coffee drinker to vary the taste and strength of the brewed cup of coffee by exchanging parts in the stationary basket.

### CROSS REFERENCE

This invention is the non-provisional patent application claiming the benefit of the earlier filed provisional patent application No. 60/649,488 filed on Feb. 3, 2005 entitled “BASKET FOR HOLDING COFFEE GROUNDS IN COFFEE BREWING MACHINE”. It is further related to the earlier filed provisional patent application No. 60/649,493 filed on Feb. 3, 2005.

### BACKGROUND OF THE INVENTION

This invention relates in general to an improved basket design for holding coffee grounds or pods in a drip coffee brewing coffee maker or machine and, more particularly, to a basket design that is usefulness in generally brewing one-cup coffee with a single pod or even a second pod if a higher predetermined strength of coffee is desired wherein a single plate with an integral basket configuration therein is inserted into the coffee maker to achieve this multiple use basket.

In the prior art, as shown in U.S. Pat. No. 4,149,454 to Kemp and U.S. Pat. No. 6,103,116 to Koslow et al, show a basket and filter assembly suitable for coffee grounds with different fixed filters and a collapsible fluid filter for filtering impurities from a fluid in a basket shape, respectively. Neither of these baskets permit the multiple uses of the present invention concerning the use of bulk coffee grounds or pods and are generally unsuitable in achieving the same results as the present invention.

The baskets and their filters disclosed are very limited in the ability to produce a cup of coffee that is brewed to the particular taste of a coffee drinker. In effect, because these basket and filters only holding a specific amount of coffee and the brewing machines who generally only hold a single, sealed and disposable pod, the user has little control over the strength of the coffee brewed in the single cup coffee makers. Moreover, the sealed disposable pods used in most of the single cup coffee makers are of no use to those persons who like to grind their own coffee beans for a brewed cup of coffee. Also, the basket and filter designs of single cup coffee makers often overflow when ground coffee beans are used instead of the enclosed pods in some instances and spill the coffee grounds into the single cup that is placed beneath the basket of the brewing machines.

Also, the use of disposable pods and/or filtering combinations is extremely expensive when compared to the use of a permanent pod where the user can use bulk ground beans. Many of the basket designs of current single cup coffee makers do not lend themselves to the use of a permanent pod to realize the savings and time required to go out and purchase new pods. These disposable pods used with the current design of the their baskets are again limited in the ability to produce a cup of coffee that is brewed to a particular taste of a coffee drinker because the disposable pods or bags hold only a limited amount of coffee beans and most of single cup brewing machines can only hold a single pod or bag so that there is little control over the strength of the coffee brewed.

### SUMMARY OF THE INVENTION

A basket for holding coffee grounds in a coffee brewing machine or maker comprising a generally cup-shaped basket integral with a plate that will slide into the slot on most single-cup coffee makers in which the depth of the bowl within the basket is alterable by the user to free the single cup coffee makers from only using a single coffee pod or from only using enough freshly ground coffee beans to make a single strength cup of coffee while maintaining the ability to still use a single pod or an amount of fresh coffee beans for a single cup of coffee. The horizontal plate and then the attached adjustable integral basket hanging down thereform allows the use of a single pod, multiple pods, permanent filtering pod (described in patent application 60/649,493) or freshly ground coffee beans of any amount to adjust the strength of the coffee brewed. So the basket and filter designs usable do not limit the user to the use of one pod, but permits the use of more than one pod, if desired. Alternatively, most single cup coffee makers do not allow the use of a permanent filtering pod or device within the bowl of the basket of the brewing machine. The basket design permits the use of permanent type pods or filters negating the necessity and cost of purchasing expensive-pods time after time. Sometimes in offices, there are loose coffee grounds available which this adjustable basket permits the use. The ability to adjust for the use of freshly ground coffee beans in the amount necessary to brew a cup of coffee to one's specific taste is generally accomplished by the use of interchangeable inserts.

A first interchangeable insert is a flat grid allowing the use of single pod. The second interchangeable insert is a resilient, deformable, modifiable cone-shaped insert that allows the use of more than one pod or a permanent filtering pod. The third interchangeable is an insert forming a permanent filtering pod. This permanent filtering pod includes a frame or body of one or more resilient, non-corrosive, heat and wear resistant material, which is easily deformable when finger pressure is applied to resilient body of the pod and then which resilient material has a memory so it quickly and easily recovers its original non-deformed shape when the finger pressure is released. The permanent filtering pod supports any other non-corrosive, heat and wear resistant mesh or finely perforated resilient or non-resilient material in which the resilient or non-resilient material forms a pod through which a liquid passes but through which the brewed coffee beans does not pass. The permanent filtering pod includes a frame or body having a slit of a predetermined length on its top. The slit opens wide when finger pressure is applied to the frame or body in the same axial direction as the slit and at each end of the slit allowing the user to scoop the beans or loose beans into a cavity within the pod and upon release of the finger pressure, the slit closes in a sealable fashion. While these three inserts of this invention are interchangeable to match or satisfy the user' specific coffee tastes, each insert acts independently of the others in the coffee maker or machine.

The permanent filtering pod is generally comprised of one or more different acid and alkali resistant, heat resistant, and wear resistant materials, such as metal, plastic, rubber or fabric. An ideal material for the permanent pod is a surgical steel micro mesh which does not flake or snag and is capable of filtering water there through even using the finest ground material when inserted into the basket with the cone-shaped extension. This surgical steel micro mesh or its equivalent in any of the other above mentioned materials is formed into a pod shape with the slit opening on its top surface for placing brewing materials therein

It is a principal object of the present invention to provide a basket design for handling a number of different pods including a permanent filtering pod for brewing beverages which allows the user to select a brewing material depending upon which interchangeable insert is used.

It is another object of the invention to provide an adjustable basket integral with a flange insertable into a single cup coffee maker to handle one or more disposable pods or even a permanent filtering pod for brewing beverages that replaces disposable pods that limits the amount and type of the selected brewing material and permits the end user to decide the amount and type of brewing materials to be used in brewing the end beverage.

Accordingly, it is yet another object of the present invention to provide an adjustable basket for a single cup coffee maker that can adopted to interchangeable inserts that allow the use of one or more disposal coffee pods or even the use of a permanent filtering pod having an opening of a predetermined size for inserting the brewing material into the cavity formed by said pod when pressure is applied to the sides of the pod deforming the same and then sealing the opening when pressure is released from the pod sides and the pod returns to its original configuration with the opening sealably closed

It is still a further object of the present invention to provide an adjustable basket for receiving interchangeable inserts in which one of the inserts is a deformable cone-shaped interchangeable insert that is placed within the adjustable basket to extend the length of the adjustable basket to permit the use of multiple pods or even a permanent filtering pod capable of carrying additional coffee grounds which would not ordinarily fit into a standard single basket of a one-cup coffee maker or the adjustable basket of the present invention without the cone-shaped insert but then will fit when the cone-shaped insert is installed in the adjustable basket

It is a another object of the invention to provide an adjustable basket for a one-cup coffee maker with interchangeable inserts in which one of the inserts is a permanent filtering pod hat fits into the basket and extends below the bottom of the basket and rests on several taps at the bottom bowl of the adjustable basket.

Yet another object of the invention is to provide an adjustable basket capable of accepting several interchangeable inserts due to strategically placed tabs located at the bottom of the cup-shaped basket at a predetermined distance from one another to receive the several different inserts related the to the number of pods or amount of coffee grounds that are used in the brewing of the coffee.

Still it is a further object of the invention to provide an adjustable basket for a single cup coffee maker that is capable of accepting a permanent filtering and deformable pod made from an acid and alkali resistant, heat and wear resistant material, such as metal, plastic rubber or fabric that is permeable to pass liquids there through which includes two longitudinal strips sealably adjacent each other along the top surface of the pod which form an opening there through into the cavity of the pod when pressure is applied to the ends of the strips but then close in their sealable relationship when pressure at the ends are released so that brewing material can be placed inside the cavity for brewing and then sealed against spilling over into the container catching the brewed liquid beverage.

Other features and advantages of the invention, which are believed to be novel and nonobvious, will be apparent from the following specification taken in conjunction with the accompanying drawings in which there is shown a preferred embodiment of the invention. Reference is made to the claims for interpreting the full scope of the invention, which is not necessarily represented by any one embodiment.

### BRIEF DESCRIPTION OF THE DRAWINGS

FIG. 1 shows an overall perspective view of an adjustable basket and integral flange for a single cup coffee maker capable of receiving several interchangeable inserts for increasing the amount of pods or beans used in the brewing process in accordance with the present invention;

FIG. 2 is a top plan view of the invention of FIG. 1;

FIG. 3 is a cut away perspective view showing a permanent filtering pod interchangeable insert in accordance with the present invention of FIG. 1; and

FIG. 4 is a perspective view with a deformable cone-shaped insert extending the depth of the adjustable basket in accordance with the invention of FIG. 1.

### DETAILED DESCRIPTION

Although this invention is susceptible to embodiments of many different forms, a preferred embodiment will be described and illustrated in detail herein. The present disclosure exemplifies the principles of the invention and is not to be considered a limit to the broader aspects of the invention to the particular embodiment as described.

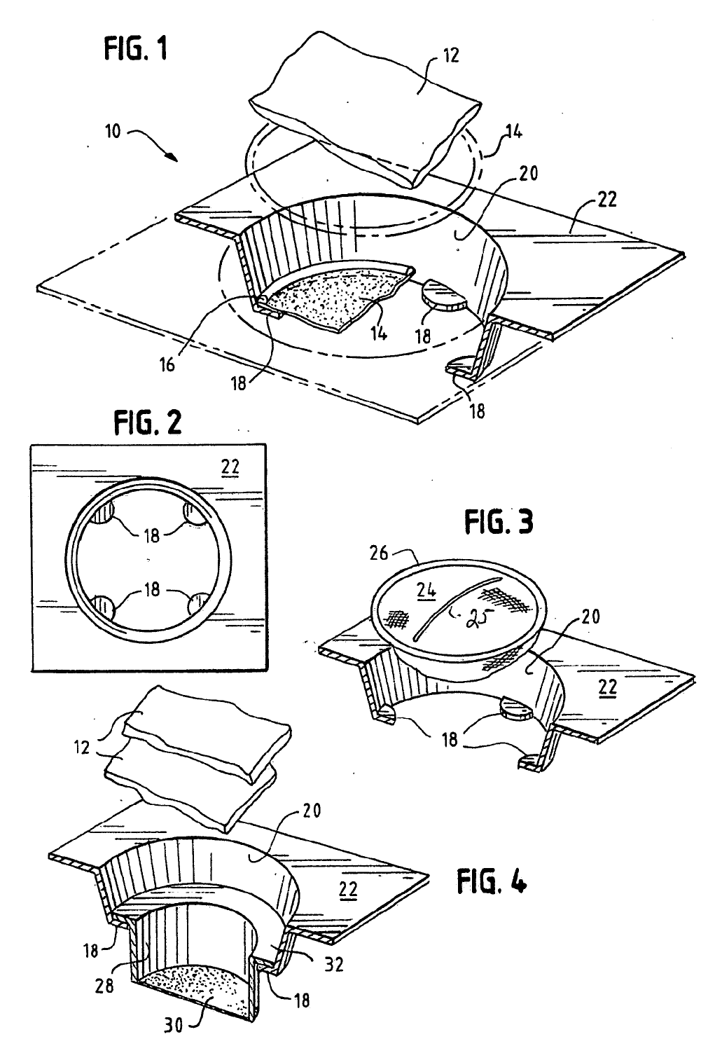

Referring now to the drawings and especially to FIG. 1 shows an adjustable basket system 10. A disposable type pod 12 is placed on top of a generally circular, resilient surgical steel micro mesh-filter 14 which does not flake off into the brew or snag the disposable pods. The filter 14 includes an annular rim 16 to engage spaced apart tabs 18 attached to the bottom of a cup-shaped basket 20 which is integral with a horizontally disposed flange 22 generally inserted into a slot (not shown) of a single cup coffee maker. The depth of the cup inner surface or bowl is approximately sufficient to receive the typical disposable pod 12 having a pre-selected amount of coffee grounds for making a single cup of coffee when the hot water form the coffee machine passes through the pod and drips through the mesh filter 14 into the coffee cup below. However, the basket 20 with the insert mesh filter 14 with its rim 16 resting on the tabs 18 generally does not accept more than a single coffee pod 12 or bag. Therefore, if the coffee drinker wants a stronger brewed coffee or a coffee brewed to a particular taste requiring different ground coffee beans, only the addition of the freshly ground beans can be placed upon the micro mesh filter 14 to brew the coffee. So it would be advantageous to adjust the depth of the coffee basket 20 to accommodate other inserts to be placed upon the tabs 18 to change the available options to the coffee drinker who wants to brew different levels of coffee beverages.

Turning now to FIG. 2, a top view of the flange 22 and the integral basket 20 are shown with generally four tabs 18 placed equidistant around the bottom circumference of inner bowl of the cup-shaped basket 20 to receive different interchangeable inserts for accommodating the different brewing needs of the coffee drinker. The tabs 18 could be considered to create a shelf for resting the interchangeable parts shown in FIGS. 1, 3 and 4. Moreover, the shelf might also be a continuous and circular ledge that extends around the entire inner circumference of the bottom opening in the stationary basket 20. In short, the tabs, shelf or continuous ledge are within the bottom of the stationary basket is used to secure the various interchangeable parts that are inserted into the stationary basket to change its configuration and ability to hold different amounts of brewing materials to adjust the taste and strength of the coffee that is being brewed by the coffee drinker.

FIG. 3 shows a permanent, deformable and resilient filtering pod 24 with a rim 26 that rests upon the tabs 18 to secure the pod 24 to the basket 20 for coffee brewing. This provides yet another interchangeable insert whereupon the coffee drinker determines which freshly ground coffee beans are used in the brewing of the coffee and permits many different options to the amount of freshly ground coffee beans are used in the brewing of the coffee. This permanent filtering pod and its operation is more fully described in a co-pending patent application No. 60/649,493 filed Feb. 3, 2005 and the co-pending non-provisional patent application filed on Feb. 2, 2006 and in which disclosure and pending applications are incorporated herein by reference thereto. In short, the permanent filtering pod 24 as described in these two patent applications includes a slit 25 across its top surface permitting the coffee drinker to flex the pod 24 with finger pressure to open the slit 25 and then insert the desired type and amount of freshly ground coffee beans into the pod 24 before placing it into the basket 20 for brewing with the single cup coffee machine.

Now, FIG. 4 shows the open bottomed stationary basket 20 with its tabs 18 with yet another interchangeable part which is a separate cone-shaped basket 28 which includes a micro mesh filter bottom 30 and a generally horizontal rim 32 integral with the vertical portion of the basket 28. The rim 32 rests upon the spaced apart tabs 18 of the stationary basket 20 when the basket 28 is inserted into the center of the stationary basket 20. This extension of the basket 20 by the separate basket 28 provides additional space to accept two or more disposable pods 12 for coffee brewing where a stronger brewed cup of coffee is desired by the coffee drinker. The micro mesh bottom 30 of the extension basket 28 would also permit more coffee grounds to be inserted into the coffee maker if freshly ground coffee beans are used instead of the extra disposable pod 12 to strengthen the coffee that is being brewed.

The present invention now is shown to have three different interchangeable parts or inserts for the basket 20 with the insertable flange 22 for a typical one cup coffee maker. A framed filtering pod 24 as shown in FIG. 3, a flat circular micro mesh grid 14 as shown in FIG. 1 and the separate basket 28 which extends the depth of the stationary basket 20. This invention gives the coffee drinker options in the type of coffee beans used as well as the potential strength of the coffee brewed which makes a single cup coffee maker, a more useful machine in coffee brewing.

Having described and illustrated the principles of the invention in a preferred embodiment thereof, it should be apparent that the invention can be modified in arrangement and detail without departing from the spirit and scope of the invention as claimed.

I claim:

1. An adjustable coffee maker basket device, comprising:
an open bottomed stationary basket connected to the coffee maker;
a predetermined number of tabs spaced apart on the circumference of the open bottom of the stationary basket;
A series of interchangeable parts resting upon said tabs for changing the configuration of the coffee maker basket so that the coffee drinker can make changes to coffee being brewed by the coffee maker; and
wherein the interchangeable parts include a permanent and resilient filtering pod with a sealable opening therein for inserting desired brewing materials; a generally flat and circular grid having a mesh permitting the flow of brewed liquid to pass therethrough but restricting the passage of brewing materials either in a pod or upon the grid surface; and a separate basket inserted within the stationary basket to extend the depth of the stationary basket and having a mesh bottom for passing the brewed liquid but restricting the passage of brewing materials therethrough.

2. The coffee maker basket device of claim 1, wherein the mesh of the grid is a surgical steel micro mesh which does not flake or snag the disposable coffee pods but permits the passage of brewed liquid therethrough without passing the brewing materials therethrough.

3. The coffee maker basket device of claim 1, wherein filtering pod interchangeable part is a generally acid, alkali, heat and wear resistant and permeable material having a slit providing the sealable opening, and wherein the slit is open when finger pressure is applied to the sides of the pod for scooping brewing materials into the pod and then the slit is sealed when the finger pressure is released from the pod making the pod ready for brewing within the basket.

4. The coffee maker basket device of claim 1, wherein the separate basket is generally a conic section terminating in a flat circular grid having a micro mesh for passing only the brewed liquid therethrough, said micro mesh is a surgical steel micro mesh which is easily cleaned by running clean water over the mesh to remove imbedded coffee grounds after continuous use for a period of time.

5. The coffee maker basket device of claim 1, wherein the grid include a resilient and deformable rim on its outer circumference resting upon the tabs and providing a framework for the mesh within its circumference so that the grid and mesh can be deformed by finger pressure and inserted into the bottom of the basket and then released to allow the rim to rest upon the tabs of the stationary basket or inserted from the top of the basket without being deformed to rest upon the tabs

6. The coffee maker basket device of claim 1, further comprising a generally horizontal and rectangular flange of a predetermined size integrally formed with the stationary basket for insertion or attachment to the typical one-cup coffee makers.

7. The coffee maker basket device of claim 1, wherein the tabs are generally of a semicircular configuration protruding outwardly a predetermined distance from the inner bottom circumference of the stationary basket to provide a securing and resting place for the interchangeable parts

8. The coffee maker basket device of claim 1, wherein the stationary basket with the grid part inserted on its tabs as the interchangeable part is capable of receiving generally a single disposable coffee pod or a measure of coffee grounds for one cup of coffee.

9. The coffee maker basket device of claim 1, wherein the stationary basket with the permanent pod inserted on its tabs as the interchangeable part allows the coffee drinker to choose the type and amount of coffee brewing materials to be inserted into the pod for the desired taste and strength of the coffee to be brewed in the coffee maker

10. The coffee maker basket device of claim 1, wherein the stationary basket with the separate basket inserted on its tabs as the interchangeable part allows the inclusion of two or more disposal coffee pods or a controlled amount of brewing materials upon its mesh which is greater than the amount of brewing materials permitted with just the grid inserted into the stationary basket to adjust the taste and strength of the coffee to be brewed.

11. The coffee maker basket device of claim 1, wherein the separate basket interchangeable part is comprised of a resilient and deformable material and further includes a generally horizontally rim of the same material attached to the downwardly extending portion of the basket allowing the rim and upper portion of the separate basket to deform with the application of finger pressure so that the separate basket and its rim can be inserted into the stationary basket from bottom opening and then to have the separate basket rim to rest upon the tabs when finger pressure is released to complete the extension of the coffee maker basket

10. The pod of claim 7, wherein the body of the stationary and separate baskets are made from a non-deformable and a deformable materials, respectively that are acid, alkali, heat and wear resistant.

11. A method for inserting interchangeable parts into an open bottomed stationary brewing basket of a coffee maker having a means at the bottom opening for securing the parts to control the brewing process, comprising:
inserting a grid as a first interchangeable part into the stationary basket that is capable of receiving at least one disposal coffee pod or a predetermined measure of coffee brewing materials;
attaching the grid to the securing means at the bottom of the stationary basket to support the coffee pod or coffee brewing materials resting thereupon;
brewing coffee by passing a hot liquid from the coffee maker through the pod or coffee brewing materials;
removing the first interchangeable part from the stationary basket;
inserting a permanent, permeable and resilient filtering pod as a second interchangeable part that is capable of receiving brewing materials of predetermined measure according to taste and strength desired by the coffee drinker wherein the resilient pod is deformable to open a sealed slit on a top surface of the pod to insert the brewing materials;
attaching the pod to the securing means at the bottom of the stationary basket to support the permeable pod partially within the stationary basket;
brewing coffee by passing a hot liquid from the coffee maker through the permanent pod having a predetermined measure of brewing materials therein;
removing the second interchangeable part from the stationary basket;
inserting a separate basket having a mesh bottom for passing brewing liquid therethrough into the stationary basket which extends the depth of the stationary basket so that the coffee drinker can place two or more disposable coffee pods or a greater amount coffee materials during the brewing process;
attaching the separate basket to the securing means at the bottom of the stationary basket to support the two or more pods or additional brewing materials;
brewing coffee by passing through a hot liquid from the coffee maker through the two or more coffee pods or additional measured coffee brewing materials to a desired taste or strength.

12. A method for inserting interchangeable parts into an open bottomed stationary basket of a coffee maker including a retention shelf located on the inner bottom opening of the stationary basket to secure the parts used to control the brewing process, comprising:
inserting a resilient grid with a permeable mesh as a first interchangeable part into the stationary basket that is capable of receiving at least one disposal coffee pod or a predetermined measure of coffee brewing materials;
attaching the grid to the shelf at the bottom of the stationary basket to support the coffee pod or coffee brewing materials resting thereupon;
brewing coffee by passing a hot liquid from the coffee maker through the pod or coffee brewing materials resting on mesh of the grid;

13. The method of claim 12, further comprising;
removing the grid from the stationary basket;
inserting a permanent, permeable and resilient filtering pod as a second interchangeable part that is capable of receiving brewing materials of predetermined measure according to the taste and strength desired by a coffee drinker wherein the resilient pod is deformable to open a sealed slit on a top surface of the pod to insert the brewing materials;
attaching the pod to shelf at the bottom of the stationary basket to support the filtering pod during the brewing process;
brewing coffee by passing a hot liquid from the coffee maker through the filtering pod.

14. The method of claim 12, further comprising:
removing the permanent pod from the stationary basket;
inserting a separate basket as a third interchangeable part having a mesh bottom for passing brewing liquid therethrough into the top of the stationary basket which extends the depth of the stationary basket so that the coffee drinker can place two or more disposable coffee pods or a greater amount coffee materials during the brewing process;
attaching the separate basket to the self at the bottom of the stationary basket to support the separate basket as it extends below the stationary basket; and
brewing coffee by passing a hot liquid from the coffee maker through the pods or coffee brewing materials and the mesh bottom of the separate basket.

15. The method of claim 14, wherein the separate basket is made from a resilient and deformable material allowing the separate basket to be deformed by finger pressure and inserted into the opening in the bottom of the stationary basket and placed onto the shelf when the finger pressure is released and the separate basket returns to its non-deformed state.

16. The method of claim 12, wherein the grid is made from a resilient and deformable material allowing the grid to be deformed by finger pressure and inserted into the opening on the bottom of the stationary basket and then placed onto the shelf when the finger pressure is released and the grid returns to its non-deformed state.

17. The method of claim 13, wherein the resilient the pod is made from a resilient and deformable material allowing the pod to be deformed by finger pressure and inserted into the opening on the bottom of the stationery basket and placed onto the shelf when the finger pressure is released and the pod returns to its non-deformed state.

18. The method of claim 12, wherein the shelf comprises a predetermined number of tabs spaced apart on the inside of open bottom of the stationary basket and extending inwardly toward the center of the opening a predetermined distance.

19. The method of claim 13, wherein the permanent pod comprises an acid, alkali, heat and wear resistant materials such as metal, plastic, rubber or fabric and such suitable material is a surgical steel micro mesh that does not flake during brewing and does not snag on other materials when used in single cup coffee makers.

20. The method of claim 13, wherein the permanent pod slit includes a pair of strips located on the top surface of the pod and extending longitudinally across the top a predetermined distance and joined at their ends to form an opening when deformed by finger pressure applied at the opposing ends of the strips.
